(19) United States
(12) Patent Application Publication
(10) Pub. No.: US 2009/0160201 A1
(43) Pub. Date: Jun. 25, 2009

(54) SHOCK-ABSORBING STRIKE ASSEMBLY FOR CLOSURES

(76) Inventors: Jeffrey Bennett Dold, Sparks, NV (US); Paul Justus Rodgers, Reno, NV (US)

Correspondence Address: Woods Oviatt Gilman LLP, 700 Crossroads Bldg, 2 State St., Rochester, NY, 14614, US

(21) Appl. No.: 12/331,485

(22) Filed: Dec. 10, 2008

Related U.S. Application Data
(60) Provisional application No. 61/008,852, filed on Dec. 20, 2007.

(51) Int. Cl. E05B 15/02

(52) U.S. Cl. 292/341.15

(57) ABSTRACT

An impact-absorbing strike assembly for a lock on a closure such as a gate. A strike plate is mounted in spaced relationship from a mounting plate. A bolt having a head extends slidably through a bore in the mounting plate and is attached to the strike plate. A primary compression spring is disposed between the mounting plate and the strike plate, and a secondary compression spring is positioned on the bolt between the head and the rear of the mounting plate. Upon closure, the momentum of the gate causes the primary spring between the strike plate and the mounting plate to be compressed, absorbing the energy of the impact. In another embodiment, an impact-absorbing strike assembly includes a latch component such as a clevis-style strike for use with a mechanical or electromechanical locking device.

### RELATIONSHIP TO OTHER APPLICATIONS AND PATENTS

The present application claims priority from U.S. Provisional Patent Application Ser. No. 61/008,852, filed Dec. 20, 2007.

### TECHNICAL FIELD

The present invention relates to mechanisms for closure of movable objects such as doors or gates; more particularly, to strike mounts for such closures; and most particularly, to a system for absorbing the shock of strike closure, especially in swinging or sliding closure of heavy doors or gates.

### BACKGROUND OF THE INVENTION

Industrial yards, construction sites, apartment complexes, office complexes and other such secured areas commonly control entry and egress. In some cases, security is accomplished by use of a security gate which may be either a sliding gate or a swinging gate which is held in the closed position by a lock which may be controlled either remotely or locally by a key, keypad, magnetic access device, RFID device, or other such control.

One particular problem with generally large and heavy gates is that when the gate is closed with application of substantial force, such as a result of wind, manual force, or an impact such as that caused by a vehicle, the resulting closing forces may cause damage to the gate installation, particularly to the lock mechanism itself. The resulting damage can inhibit proper operation of the gate and result in substantial maintenance and repair costs to correct the damage. An additional problem is that the momentum of a heavy closing gate often causes the automatic lock to fail to stay secured under the rebounding forces of the gate.

What is needed in the art is a resilient strike assembly to reduce the impact of lock engagement and to absorb some of the closing forces of a heavy door or gate.

It is a principal object of the present invention to reduce the risk of damage to a lock during locking engagement.

It is a further object of the invention to improve the reliability of a secured closure during a closing event.

### SUMMARY OF THE INVENTION

Briefly described, an impact-absorbing strike assembly for a lock on a closure such as a gate and post has a strike plate mounted in spaced relationship from a mounting plate. A connecting element, preferably a bolt having a head, extends slidably through a bore in the mounting plate and is attached to the strike plate. A primary compression spring is disposed between the mounting plate and the strike plate, preferably surrounding the bolt. A secondary compression spring is positioned on the bolt between the head and the rear of the mounting plate. Upon closure, the strike plate engages and is held by the latch or lock mounted on a fixed structure such as a gate post. Alternatively, the strike assembly may be mounted on the gate post, with the latch mounted on the gate. The momentum of the gate causes the spring between the strike plate and the mounting plate to be compressed, absorbing the energy of the impact as the bolt slides in the mounting plate. Resilient movement of the strike plate may be further guided by pins pressed into the strike plate that extend through grommets located in bores in the mounting plate. Once the primary, shock-absorbing spring has been compressed and has absorbed the impact or load, the primary spring expands from a compressed state, causing the secondary spring to be compressed between the head of the bolt and the rear of the mounting plate. After progressively decreasing oscillations, the strike assembly returns to a steady state condition with the gate in a closed position.

In another embodiment, the impact-absorbing strike assembly includes a latch component such as a clevis-style strike for use with a mechanical locking device that may be electromechanical.

### BRIEF DESCRIPTION OF THE DRAWINGS

The present invention will now be described, by way of example, with reference to the accompanying drawings, in which:

FIG. 1 is an exploded perspective view showing a first embodiment of a shock-absorbing strike assembly in accordance with the present invention;

FIG. 2 is a side view of the shock-absorbing strike assembly shown in FIG. 1;

FIG. 3 is a perspective view showing the shock-absorbing strike assembly shown in FIGS. 1 and 2 mounted on a swinging gate and positioned to engage a gate post having an electromagnetic latch;

FIG. 4 is a side view taken sequentially after the view shown in FIG. 3, showing the strike plate engaged by the electromagnetic latch with the mounting plate compressing the shock-absorbing spring;

FIG. 5 is a side view taken sequentially after the view shown in FIG. 4, showing the gate closed and the compression impact-absorbing spring expanded (rebounded) to its normal position; and

FIG. 6 is a perspective view showing a second embodiment of a shock-absorbing strike assembly in accordance with the present invention, in connection with a mechanical lock.

Corresponding reference characters indicate corresponding parts throughout the several views. The exemplifications set out herein illustrates one preferred embodiment of the invention in one form, and such an exemplification is not to be construed as limiting the scope of the invention in any manner.

### DESCRIPTION OF THE PREFERRED EMBODIMENTS

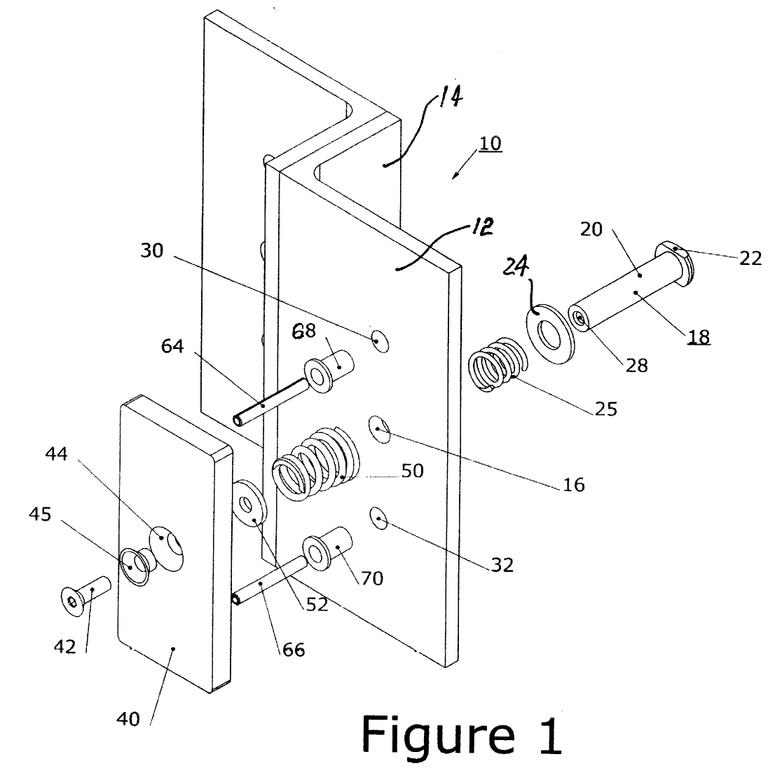

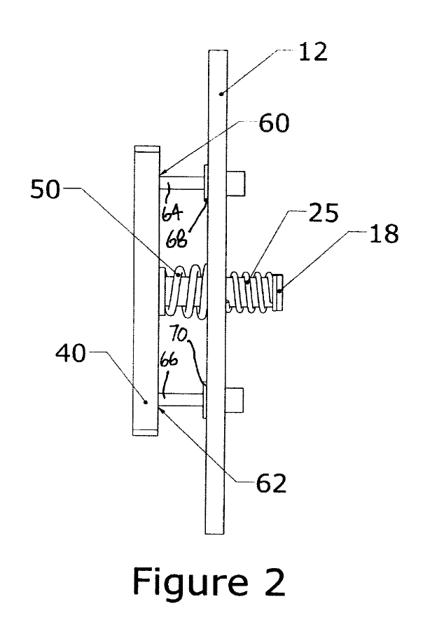

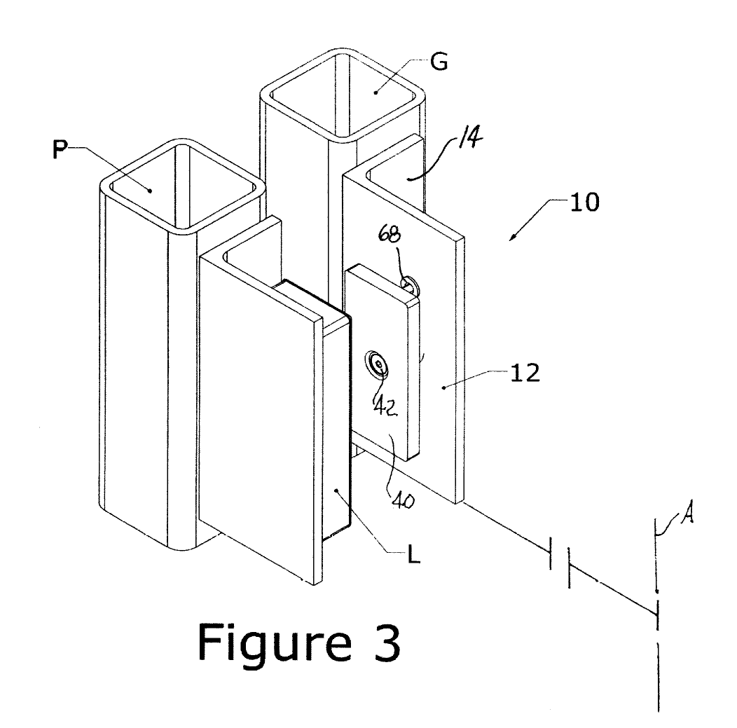

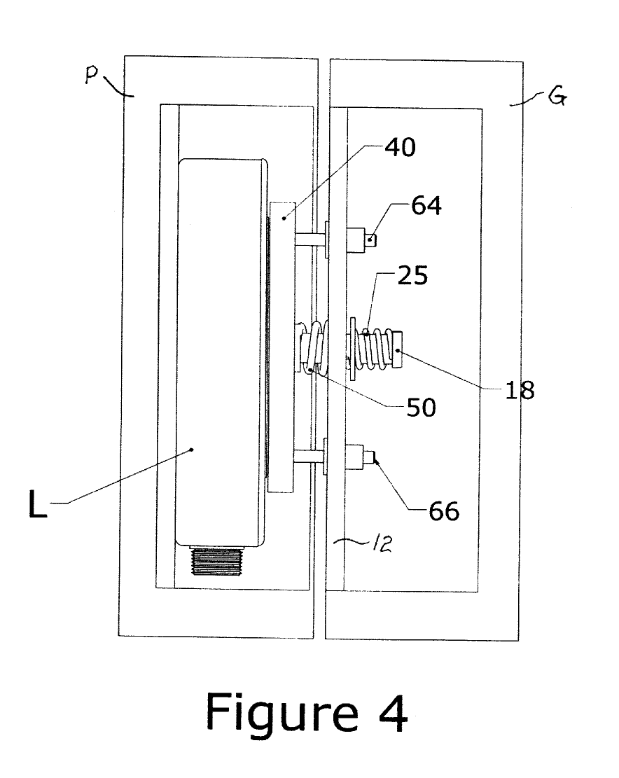

Referring to FIGS. 1 through 5, a first embodiment of shock-absorbing suspension strike assembly in accordance with the present invention is designated generally by the numeral 10 and is installed on a closure, such as on the frame section of a swinging gate G as shown in FIG. 3. Strike assembly 10 may be used in connection with other types of closures, such as sliding gates and heavy doors, and operates in the same manner.

Strike assembly 10 may be adapted for use with closures of various configurations but is especially useful on closures involving heavy duty gates. As described above, heavy duty gates for industrial or commercial use have substantial mass and can have substantial kinetic energy. Excessive loads imposed on a strike by a heavy gate closing or by other forces, such as by impact of a vehicle striking the gate, can cause the gate to close with excessive force, damaging the gate, gate posts, and/or lock components. Strike assembly 10 operates to absorb much of the closing impact, reducing damage and wear to a gate and preventing misalignment as may occur from the damage due to high impact conditions.

Strike assembly 10 is intended specifically for gates having electromagnetic locks or latches L as shown in FIG. 3. Such latches typically include an electromagnetic component comprising one or more electromagnets permanently fixed to a gate frame or a gate post and selectively energizable. An electromagnetic latch, when engaged by a strike plate of magnetically susceptible material, will hold the strike plate in engagement until the magnetic force is released, thus controlling the opening and closing operation of the gate. An electromagnetic latch may be energized and controlled by various means well known in the prior art such as a keypad, keys, RFID tag, or the like, either locally or remotely.

Strike assembly 10 includes a mounting plate 12, shown as being generally rectangular but which may be of any configuration and size. Preferably, mounting plate 12 is formed of a durable material, for example, a hardened stainless steel, and may be secured to the moveable portion of gate G at an L-shaped flange 14 which is secured to gate G by welding or fasteners; welding is preferred to minimize tampering and to deter intrusions. Gate G is shown as a swinging gate in FIGS. 3 through 5, but may also be a sliding gate or other closure. Strike assembly 10 operates in the same manner for these types of installations. Mounting plate 12 has a bore 16 which slidably receives a connecting element 18 preferably in the form of a bolt having an elongate, cylindrical body 20 with a head 22 at one end. Body 20 is slidably received in bore 16. A secondary compression spring 25 is interposed between head 22 and the rear of mounting plate 12. Washer 24 may be disposed between one end of compression spring 25 and the rear of the mounting plate. The distal end of connecting element 18 defines a threaded counterbore 28. A magnetic strike plate 40 in normally spaced relationship with mounting plate 12 is secured to connecting element 18 by a suitable fastener 42 that extends through bore 44 in strike plate 40. A grommet 45 insulates connecting element 18 and fastener 42 from strike plate 40. Preferably, bore 44 is countersunk to receive the tapered head of fastener 42, providing a flush surface to strike plate 40.

Alternatively, bore 44 is omitted, and connecting element 18 threads into a threaded bore (not shown) formed in the rear surface of strike plate 40, or connecting element 18 may be welded to strike plate 40 with head 22 attachable to the connecting element for securing mounting plate 12 in place.

A primary compression spring 50, stronger than secondary compression spring 25, is disposed on connecting element 18 interposed between mounting plate 12 and strike plate 40. A washer 52 may be disposed between one end of compression spring 50 and strike plate 40.

One or more guide bores 30,32 are provided in mounting plate 12 disposed adjacent bore 16. Bushings 68, 70 are disposed in guide bores 30,32, respectively. A pair of blind bores 60,62 on the inner face of strike plate 40 are positioned to align with guide bores 30,32 in mounting plate 12. Guide pins 64,66, formed preferably of stainless steel or a similar material, are pressed into blind bores 60,62 and are slidingly received in bushings 68,70 so that as primary compression spring 50 is compressed, the reciprocal movement of strike plate 40 relative to mounting plate 12 is guided by guide pins 64,66. Bushings 68,70 may be secured to mounting plate 12 by a suitable fastener such as, for example, a thread locker.

Referring now to FIGS. 3 through 5, the installation of shock-absorbing strike assembly 10 is shown. Mounting plate 12 is secured to the frame of the moveable portion of gate G with strike plate 40 aligned with electromagnetic latch L on the gate structure, in this case the gate post P. When the gate is properly positioned, strike plate 40 and latch L are in alignment and, when electrical energy is applied to electromagnetic latch L, the magnetic components and strike plate 40 are held and maintained in engagement in a locked condition. When electrical energy is interrupted, the magnetic attraction between these two components is dissipated and the gate may be opened. As discussed above, the electrical circuit may be operated by various known controllers such as keypads or other expedients known to those skilled in the art.

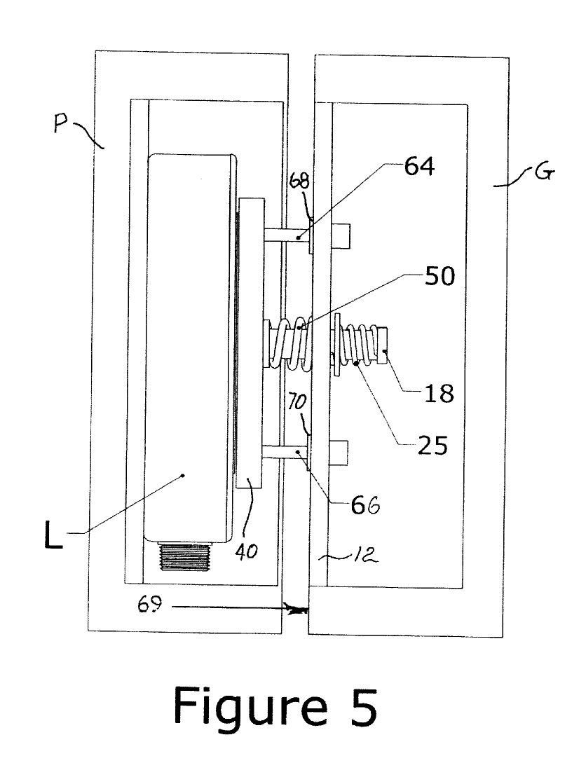

In FIGS. 3 through 5, gate G is shown as a swinging gate and moves in an arcuate path about a pivot axis A. In operation, when the moveable closure section of gate G is closed with excessive force, strike plate 40 impacts latch L, and magnetic attraction engages and holds strike plate 40 in position against latch L. The momentum of gate G, however, causes gate G (and mounting plate 12) to continue to move in a path toward latch L, resulting in compression of primary spring 50 and thereby absorbing energy which may otherwise cause damage to the gate. Once spring 50 is compressed as a result of the impact load imposed and absorbed, spring 50 begins to expand, forcing mounting plate 12 (and gate G) away from strike plate 40. This rebound results in compression of secondary spring 25 on the rear side of mounting plate 12. A shoulder (not shown) disposed adjacent head 22, that is larger in diameter than bore 16 but smaller in diameter than the inner diameter of spring 25, may be used to prevent spring 25 from being compressed to solid height from the opposing and stronger force of spring 50. Compression of secondary spring 25 dampens the impact of head 22 on mounting plate 12 as primary spring 50 expands following impact. The impact and rebounding movements of gate G eventually settle with gate G in the normal, closed position seen in FIG. 5, wherein impact loads have been substantially absorbed, reducing the possibility of damage to the gate assembly or the rebounded gate coming to rest in a non-closed position.

Secondary spring 25, with a properly selected spring rate, may be useful in resisting attempts to force gate G open by an unwanted application of a sharp, impact force against the gate in direction 69 in FIG. 5. By selecting a spring rate of secondary spring 25 where the force of spring 25 balances the opposing force of primary spring 50 when the gate is closed, a sharp impact force applied to gate G in direction 69 permits some movement of gate G away from latch L and strike plate 40 with the compression of secondary spring 25. Its compression will serve to absorb the impact force permitting strike plate 40 to remain in contact with latch L, or at least under the magnetic closing force of latch L, thereby keeping the gate closed.

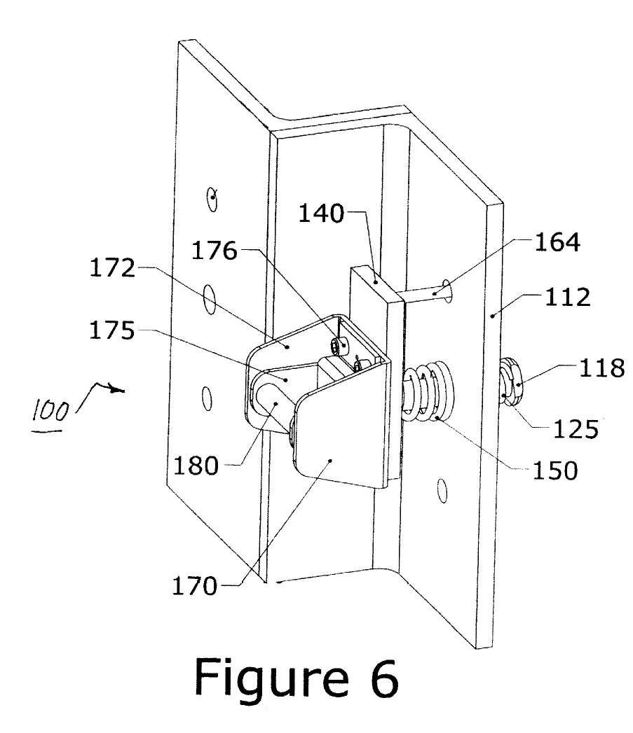

Referring now to FIG. 6, a second embodiment of a shock-absorbing strike assembly in accordance with the present invention is generally designated by the numeral 100. Strike assembly 100 has a mounting plate 112 which slidably receives connecting element 118. Mounting plate 112 preferably is L-shaped, allowing attachment to a structure such as a post or closure structure. A secondary compression spring 125 is interposed between a head of connecting element 118 and the rear of the mounting plate 112.

A strike plate 140 is spaced from mounting plate 112 and is secured to connecting element 118 as by a fastener or other means. A primary compression spring 150 stronger than secondary spring 125 is disposed on connecting element 118 interposed between mounting plate 112 and strike plate 140. One or more pins 164 may be used to guide the reciprocal movement of strike plate 140.

Embodiment 100 is intended for use with non-electromagnetic locks. Accordingly, strike subassembly 170 preferably comprises an outer clevis 172 which pivotally supports an inner clevis 175. Clevis 175 is secured to outer clevis 172 and strike plate 140 by fasteners 176 and has a sleeve 180 that is captured within a cooperating mechanical latch component (not shown) when the closure components are engaged. The installation and shock absorbing operations are as described above with respect to FIGS. 1 through 5 as primary spring 150 is compressed to absorb shock when the latch and clevis impact. The opposing forces of primary spring 150 and secondary spring 125 return strike plate 140 and strike subassembly 170 to a normal position.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A strike assembly for a closure having a fixed member and a moveable member, comprising:
a) a mounting plate connected to one of said fixed member or said movable member;
b) a strike plate off-spaced from said mounting plate; and
c) an energy absorbing member disposed to absorb energy when said strike assembly impacts the other of said fixed member or said movable member.

2. A strike assembly in accordance with claim 1 further comprising a connecting element associated with said strike plate and movably coupled to said mounting plate.

3. A strike assembly in accordance with claim 2 wherein said connecting element is a bolt having a head.

4. A strike assembly in accordance with claim 1 wherein said energy absorbing member is disposed between said mounting plate and said strike plate.

5. A strike assembly in accordance with claim 4 wherein said energy absorbing member is a first compression spring.

6. A strike assembly in accordance with claim 5 further comprising a second compression spring disposed between said connecting element and said mounting plate.

7. A strike assembly in accordance with claim 1 further comprising at least one guide pin attached to one of said mounting plate or said strike plate and slidingly received by the other of said mounting plate or said strike plate.

8. A strike assembly in accordance with claim 2 wherein said energy absorbing member is disposed on said connecting element.

9. A strike assembly in accordance with claim 1 wherein said other of said fixed member or said movable member includes an electromagnetic mating lock and said strike plate is formed of a magnetically susceptible material for mating with said electromagnetic lock.

10. A strike assembly in accordance with claim 1 further comprising a clevis subassembly mounted on said strike plate.

11. A strike assembly in accordance with claim 10 wherein said other of said fixed member or said movable member includes a mating mechanical lock for engaging said clevis subassembly.

12. A closure comprising:
a) fixed member;
b) a movable member;
c) a lock disposed on one of said fixed member or said movable member; and
d) a strike assembly including a mounting plate connected to the other of said fixed member or said movable member, a strike plate and an energy absorbing member disposed between said mounting plate and said strike plate to absorb energy when said strike assembly impacts the said lock.

13. A closure in accordance with claim 12 wherein said lock is selected from the group consisting of electromagnetic lock, mechanical lock, and electromechanical lock.

14. A closure in accordance with claim 12 wherein said fixed member is a post and said movable member is a gate.

15. A closure in accordance with claim 14 wherein said gate is selected from the group consisting of swinging gate and sliding gate.

16. A closure in accordance with claim 12 further comprising a connecting element associated with said strike plate and movably coupled to said mounting plate
